(19) United States
(12) Patent Application Publication
(10) Pub. No.: US 2015/0010388 A1
(43) Pub. Date: Jan. 8, 2015

(54) DAMPER FOR DAMPING PRESSURE WAVES

(71) Applicant: VENEVEISTÄMÖ SYRJÄSUO OY, Piikkiö (FI)

(72) Inventor: Esko Syrjäsuo, Turku (FI)

(73) Assignee: VENEVEISTÄMÖ SYRJÄSUO OY, Piikkiö (FI)

(21) Appl. No.: 14/368,158

(22) PCT Filed: Dec. 21, 2012
(86) PCT No.: PCT/FI2012/051289

§ 371 Date: Jun. 23, 2014

(30) Foreign Application Priority Data
Dec. 22, 2011 (FI) 20116305

(51) Int. Cl. B63H 1/15; F16F 9/30; B63B 17/00; F16F 9/00

(52) U.S. Cl. CPC B63H 1/15; F16F 9/003; F16F 9/306; B63B 17/0081
USPC 415/119; 188/268

(57) ABSTRACT

The invention relates to a damping device for damping a pressure wave generated by a propeller. The damping device comprises a surface structure, which delimits a closed space, which contains gas. The damping device further comprises a flexible structure, which is arranged in the closed space delimited by the surface structure, and which flexible structure forms channels, through which the gas can flow. The invention also relates to a propeller-driven vessel and a propulsion device.

### TECHNICAL FIELD OF THE INVENTION

The invention relates to a damping device for damping pressure waves according to the preamble of the independent claim presented below. The invention also relates to a propeller-driven vessel and a propulsion device of a vessel.

### BACKGROUND OF THE INVENTION

A propeller of a vessel, such as a boat or ship, generates strong pressure waves when rotating. When the pressure waves travelling in the water hit the bottom of the vessel, pressure shocks vibrate the body of the vessel, which is felt as an unpleasant vibration inside the vessel. Additionally the vibrations of the body of the vessel caused by the pressure shocks increase the internal noise level of the vessel.

Solutions for the problem have been searched for among others in the designing of the bottom of the vessel and the blades of the propeller. The effects have however remained small. This is because the designing of the bottom and the propeller must primarily concentrate on the travelling properties of the vessel. The internal noise level of the vessel has traditionally been attempted to be lowered with sound-absorbing panels attached on the inside of the vessel. The sound-absorbing panels can however not reduce the vibrations of the body of the vessel, which are caused when the pressure waves generated by the propeller hit the bottom of the vessel.

One known solution for reducing the effects of the pressure waves generated by the propeller is presented in publication JP 8188192. Publication JP 8188192 presents a damping device, which comprises a rubber film, which is attached to the outer edges of a recess in the stern part of a ship. The device further comprises a ballast tank, from which water is pumped along a supply pipe into the rubber film. When the pressure wave generated by the propeller hits the rubber film, the rubber film collapses and water flows back into the ballast tank along a return pipe. Instead of ballast water the damping device can use gas. The publication JP 8188192 however states that the damping effect of the device in that case remains too small.

A problem with the damping device presented in publication JP 8188192 is that its operating principle is complicated and it requires electric energy to function. A problem with the device is further that its capability of reacting to quick pressure variations is not sufficient in all situations.

### OBJECTS OF THE INVENTION

It is an object of the present invention to reduce or even completely eliminate the above-mentioned problems and flaws, which appear in the prior art.

It is an object of the present invention to provide a damping device, with which pressure shocks generated by pressure waves can be dampened. It is especially an object of the invention to provide a damping device, with which the vibrations of the body of the vessel caused by the pressure waves generated by the propeller can significantly be reduced, and thus the internal noise level of the vessel can be reduced.

It is also an object of the present invention to provide a damping device, which operates without electric energy and is thus very energy-efficient.

It is additionally an object of the present invention to provide a damping device, which can easily be installed in the bottom of a vessel also as retrofitting.

It is also an object of the present invention to provide a vessel, the vibrations of the body of which are slight and the internal noise level of which is low.

It is further an object of the present invention to provide a propulsion device, the vibrations caused by which to the vessel are slight.

The above-mentioned disadvantages can be reduced or even completely eliminated, and the above-defined objects are attained with the present invention, which is characterised in what is defined in the characterising part of the independent claim presented further below.

Some preferred embodiments according to the invention are disclosed in the dependent claims presented further below.

### DESCRIPTION OF THE INVENTION

A typical damping device according to the invention for damping pressure waves comprises a surface structure, which delimits a closed space, which contains gas.

A typical damping device according to the invention is characterised in that the damping device comprises a flexible structure, which is arranged in the closed space delimited by the surface structure, and which flexible structure forms channels, through which the gas can flow.

Inside a typical damping device according to the invention there is thus a closed space containing gas, wherein a flexible structure is arranged. A flexible structure in this text means a flexible structure, which resists deformation of the damping device. When an external force is directed at the damping device, which force compresses the damping device, the flexible structure generates an opposite force to this force, which opposite force strives to return the damping device to its normal state. The flexible structure is typically characterised in that the more the damping device is compressed, the greater the force generated by the flexible structure is, which force strives to return the damping device to its original shape.

A closed space in this text means that the space is completely surrounded by the surface structure. Advantageously no gas or liquid can flow into the space delimited by the surface structure or out of it. In other words the surface structure is advantageously both gas- and liquid-tight.

The purpose of the channels formed in the closed space is to even out internal pressure differences in the damping device, which pressure differences are generated when a pressure wave hits the damping device. Because the forces generated by the pressure wave hitting the damping device are typically not evenly distributed over the surface of the damping device, the damping device behaves differently in its different parts. In the area affected by the greatest forces the damping device is compressed the most, due to which the gas in the damping device flows along the channels in the space to areas, which are affected by the smallest forces generated by the pressure wave.

An advantage of a typical damping device according to the invention is that it can be used for efficiently damping pressure shocks generated by pressure waves. The damping device according to the invention is suited for damping pressure waves advancing in liquid, especially in water. When a pressure wave hits the surface of the damping device, the energy contained in the pressure wave is efficiently absorbed into the flexible structure of the damping device. Thus the damping device, which is attached to the bottom of a vessel, efficiently prevents pressure shocks from being conveyed to the body of the vessel.

The damping device according to the invention is especially suited for damping pressure waves generated by a propeller rotating in water. The cavitation of the propeller substantially affects the magnitude of the pressure wave generated by the propeller. The more the propeller cavitates, the greater the pressure wave provided thereby is. The number of blades of the propeller also affects the magnitude of the pressure wave. The fewer blades in the propeller, the greater a pressure shock it causes and the smaller the impulse frequency of the pressure shocks generated by the propeller is.

A damping device, which is installed in the bottom of a vessel, such as a boat or ship, significantly reduces the vibrations of the body of the vessel caused by the pressure waves generated by the propeller, and thus reduces the internal noise level of the vessel.

The damping device is advantageously installed in the bottom of the vessel so that the direction of the channels is substantially the same as the longitudinal direction of the vessel. Thus the pressure wave generated by the propeller sweeps the surface of the damping device in a direction, which is substantially perpendicular to the direction of the channels. An advantage is that thus when the flexible structure is compressed, the gas in the channels can easily be discharged out of the channels.

The rigidity of the damping device can vary in its different parts. The rigidity of the damping device is advantageously smaller in the edges than in the middle.

An advantage of a typical damping device according to the invention is that the damping device does not require electric energy in order to function.

An advantage of a typical damping device according to the invention is additionally that it can easily be installed in the bottom of a vessel also as retrofitting.

The surface structure of the damping device is advantageously manufactured from a bendable material, such as for example rubber or another corresponding material. The surface structure of the damping device is advantageously manufactured from chloroprene rubber. The outer surface of the surface structure can be smooth or it can be provided with grooves for reducing the rigidity of the surface structure. The grooves in the outer surface are advantageously substantially parallel with each other.

The flexible structure of the damping device is advantageously manufactured from a flexible and/or elastic material, such as for example rubber or another corresponding material suited for the purpose. Among others the size and shape of the flexible structure affect the material choice. The flexible structure can be manufactured for example from polyurethane or EPDM rubber.

The gas used in the damping device can for example be air or another gas suited for the purpose. The gas pressure can be selected for example according to the water pressure surrounding the damping device.

The size and number of the channels formed by the flexible structure can vary among others according to the size of the damping device and the use target of the damping device. The number of channels can for example be under 10, 10-30, 30-100 or over 100. The channels are typically substantially straight, but in some situations curved channels can also be used. The channels are advantageously arranged so that they are parallel with each other. The channels advantageously extend substantially through the closed space, in other words substantially from the inner surface to the inner surface of the surface structure.

According to an embodiment of the invention the surface structure comprises a first surface plate and a second surface plate, which are attached together at their edges. The surface plates are advantageously substantially rectangular. The surface plates can for example be chloroprene rubber plates. The thickness of the surface plates can for example be less than 1 mm, 1-3 mm, 3-10 mm, 10-20 mm, 20-50 mm or over 50 mm.

The damping device is typically dimensioned according to the use target and purpose. The length of the damping device can for example be less than 30 cm, 30-100 cm, 100-300 cm or over 300 cm and its width can for example be less than 30 cm, 30-100 cm, 100-300 cm or over 300 cm. The damping device is advantageously dimensioned so that its thickness is significantly smaller than its length and width. The thickness of the damping device can for example be less than 2 cm, 2-5 cm, 5-10 cm, 10-30 cm or over 30 cm.

According to an embodiment of the invention the flexible structure comprises tubes, which are arranged longitudinally between the surface plates. The diameter of the tubes can for example be less than 10 mm, 10-30 mm, 30-100 mm or over 100 mm and the thickness of the walls of the tubes can for example be less than 0.5 mm, 0.5-2 mm, 2-10 mm, 10-20 mm or over 20 mm. Because the tubes are hollow and open at both ends, channels are formed in them, along which the gas can flow. The tubes are advantageously manufactured from EDPM rubber.

The tubes can be arranged between the surface plates in different ways. The tubes can be superposed and/or side by side. The tubes can be against each other or at a suitable distance from each other, for example 10-20 mm, 20-50 mm or over 50 mm from each other.

The damping device, the flexible structure of which has tubes, is advantageously installed in the bottom of the vessel so that the direction of the tubes is substantially the same as the longitudinal direction of the vessel.

According to an embodiment of the invention the tubes are arranged to be parallel with each other. An advantage is that thus the damping device functions especially well in a situation, where the pressure wave sweeps the surface of the damping device substantially in one direction. Such a situation arises for example when the damping device is installed between the bottom of a vessel and a propeller, so that the direction of the tubes is substantially the same as the longitudinal direction of the vessel.

According to an embodiment of the invention the tubes are arranged in at least two layers. The tubes can be arranged in layers for example so that the tubes in one layer are aligned or overlapped with the tubes in the second layer. The layers can be separated from each other for example with a partition plate.

The tubes can also be arranged in several layers, for example three, four or five layers. The layers are advantageously arranged so that the tubes are parallel with each other.

According to an embodiment of the invention the flexible structure comprises elements shaped as rectangular prisms, which are arranged longitudinally between the surface plates. The elements are arranged so that channels are formed between them, along which channels the gas can flow. In other words the elements are not arranged in contact with each other, but they are arranged at a suitable distance from each other. The elements can for example be arranged so that they form channels in one or two directions. The elements of the flexible structure are advantageously manufactured from polyurethane.

According to an embodiment of the invention the flexible structure is attached to the inner surface of the surface structure. The flexible structure can be attached for example to both surface plates of the surface structure, whereby it supports the structure of the damping device.

According to an embodiment of the invention the damping device has a plate-like shape. The plate-like damping device functions as a vibration isolator with a wide surface. The plate-like damping device is due to its shape especially well suited for installation in the bottom of a vessel, because then the streamlined shape of the bottom of the vessel can be retained.

The invention also relates to a propeller-driven vessel, where a typical damping device according to the invention has been arranged between the propeller and the bottom of the vessel. A damping device, which is installed between the propeller and the bottom of the vessel, can significantly reduce the vibrations of the body of the vessel caused by the pressure waves generated by the propeller, and thus reduce the internal noise level of the vessel. The vessel in this text means a ship or a boat. The length of the vessel can for example be less than 10 m, 10-50 m, 50-150 m or over 150 m.

The magnitude of the pressure shock caused by the propeller varies in different vessel types. The magnitude of the pressure shock depends among others on the power source used in the vessel, which can for example be a mid engine or an inboard motor. The length of the vessel does not directly affect the magnitude of the pressure shock, but because the power of the motor and the size of the propeller usually increase as the length of the vessel increases, the magnitude of the pressure shock thus also increases.

When the vessel advances at travel speed, the blade frequency of the propeller can for example be 80-90 Hz. The vertical resonance frequency of the damping device should according to one design rule thus be at the most 30 Hz, advantageously even less than 10 Hz. A general rule of the design rule is that the lower the frequency of the resonance can be set, the more efficiently the damping device can be made to dampen. At frequencies below 100 Hz, increasing the flexibility of the damping device is a good way to increase the damping. Experiments have shown that when using a damping device according to the invention, the A-weighted total noise level inside the vessel decreases by up to 10 dB.

According to an embodiment of the invention the damping device is attached to the bottom of the vessel. The damping device is advantageously attached above the propeller in a point, where the sweep of the pressure wave provided by the propeller mainly hits.

According to an embodiment of the invention the damping device is attached to a recess in the bottom of the vessel. An advantage of a damping device arranged in a recess is that the bottom of the vessel can thus be shaped in an optimal manner.

According to an embodiment of the invention the bottom of the vessel forms a part of the surface layer of the damping device. A part of the bottom of the vessel can for example function as one of the surface plates of the damping device. The damping device can be formed for example in a recess in the bottom of a vessel so that the first surface plate is attached to the edges of the recess, and the part of the bottom of the vessel, which forms the recess, functions as the second surface plate.

The invention also relates to a propulsion device of a vessel, which comprises a propeller and a cavitation plate arranged in connection with the propeller and a damping device according to the invention attached to the cavitation plate. The cavitation plate is situated above the propeller, and it is intended to be arranged slightly below the water surface when using the propulsion device. The purpose of the cavitation plate is to prevent air from ending up in the propeller flow. Due to the cavitation plate the propeller does not easily start to spin without resistance. The damping device is arranged between the propeller and the cavitation plate. The damping device is attached to the lower surface of the cavitation plate, above the propeller.

The propulsion device comprises a motor, such as a petrol, diesel or electric motor, for rotating the propeller. The pressure waves generated by the rotating propeller hit the cavitation plate, from where the vibration is relayed to the vessel via the attaching structures of the propulsion device. Due to the damping device attached to the cavitation plate the vibrations generated by the pressure waves and relayed to the vessel can be made very slight.

The propulsion device according to the invention can for example be an outboard or inboard motor. An outboard motor means a combination of a motor and propeller attached to the stern of the vessel, where the motor rotates the propeller axis, whereto the propeller is attached. The motor of the inboard motor is situated inside the vessel.

The embodiments and advantages mentioned in this text are in suitable parts applicable to both the damping device and the vessel according to the invention, even if this is not always specifically mentioned.

### BRIEF DESCRIPTION OF THE DRAWING

In the following the invention will be described in more detail with reference to the embodiments presented as examples and the enclosed figures, in which

FIG. 1 shows a damping device according to a first embodiment of the invention as a cross-section,

FIG. 2 shows a damping device according to a second embodiment of the invention as a cross-section,

FIG. 3 shows a damping device according to a third embodiment of the invention as a cross-section,

FIG. 4 shows a propeller-driven vessel according to an embodiment of the invention, and

FIG. 5 shows a propulsion device according to an embodiment of the invention.

### DETAILED DESCRIPTION OF THE DRAWING

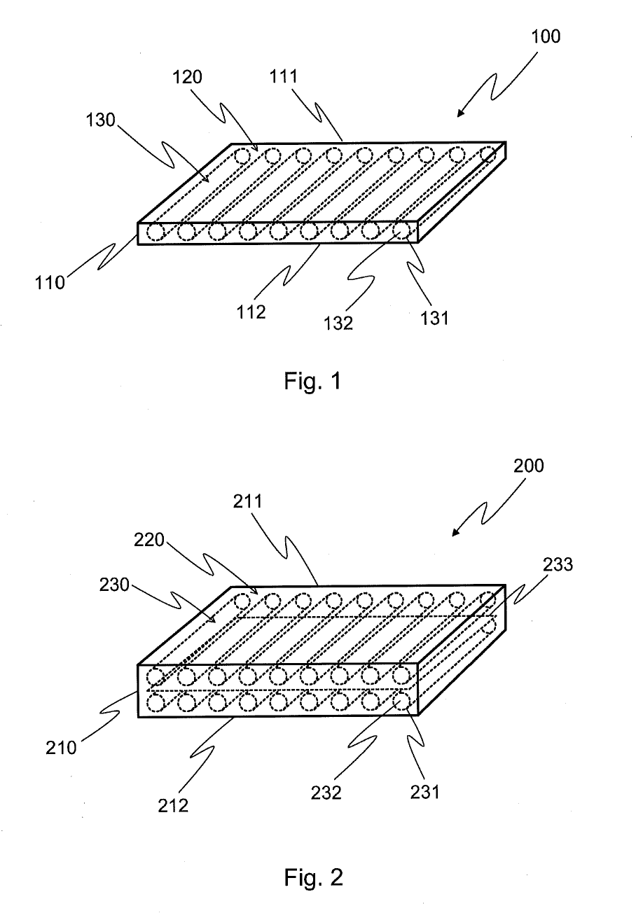

FIG. 1 shows the structure of a damping device according to a first embodiment of the invention. The damping device 100 comprises a surface structure 110, which delimits within it a closed space 120, which contains gas. The surface structure 110 comprises a first surface plate 111 and a second surface plate 112, which are attached together at their edges.

The damping device 100 additionally comprises a flexible structure 130, which is arranged in the closed space 120 delimited by the surface structure 110. The flexible structure 130 comprises tubes 131, which are arranged longitudinally between the surface plates 111, 112. In the damping device 100 shown in FIG. 1 the tubes 131 are arranged in parallel between the surface plates 111, 112, so that they are not in contact with each other.

Because the tubes 131 are hollow and open at their ends, the inner parts of the tubes 131 function as channels 132, through which the gas can flow. The channels 132 even out the pressure differences inside the damping device 100, which pressure differences are formed when the damping device 100 is compressed, for example when a pressure wave hits the damping device 100. The gas can move along the channels 132 to areas, where the damping device 100 is least compressed.

FIG. 2 shows the structure of a damping device according to a second embodiment of the invention. Correspondingly to the damping device 100 according to FIG. 1, the damping device 200 according to FIG. 2 comprises a surface structure 210, which delimits within it a closed space 220, which contains gas. The surface structure 210 comprises a first surface plate 211 and a second surface plate 212, which are attached together at their edges.

The damping device 200 comprises a flexible structure 230, which is arranged in the closed space 220 delimited by the surface structure 210. The flexible structure 230 comprises, just as in the damping device 100 shown in FIG. 1, tubes 231, which are arranged longitudinally between the surface plates 211, 212. In the damping device 200 according to FIG. 2 the tubes 231 are arranged in two layers, so that the tubes in the first layer are aligned with the tubes in the second layer. The inner parts of the tubes 231 form channels 232 inside the damping device 200, through which channels the gas can flow. The layers are separated from each other with a partition plate 233.

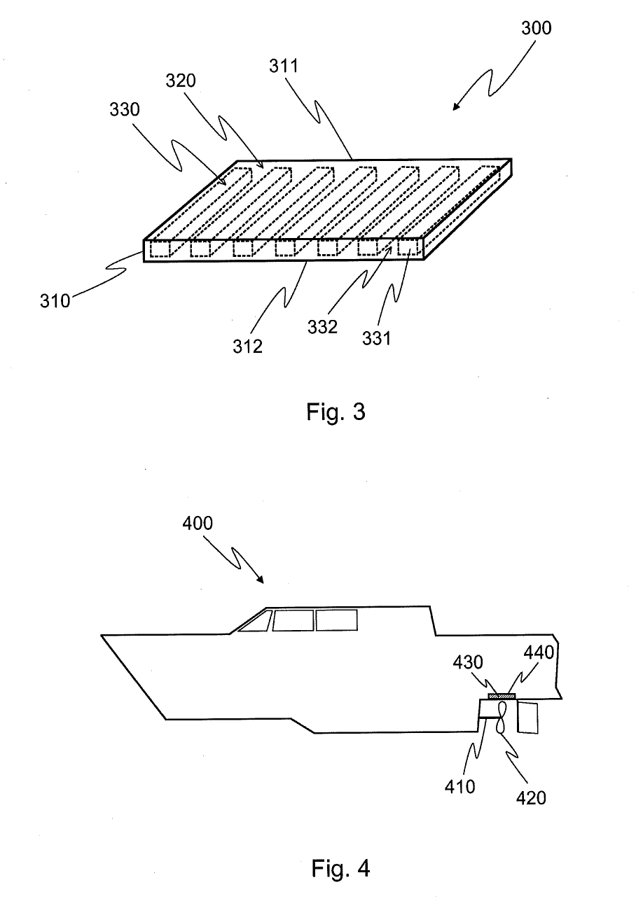

FIG. 3 shows the structure of a damping device according to a third embodiment of the invention. Correspondingly to the damping device 100 according to FIG. 1, the damping device 300 according to FIG. 3 comprises a surface structure 310, which delimits within it a closed space 320, which contains gas. The surface structure 310 correspondingly comprises a first surface plate 311 and a second surface plate 312, which are attached together at their edges.

The damping device 300 comprises a flexible structure 330, which is arranged in the closed space 320 delimited by the surface structure 310. The flexible structure 330 comprises elements 331 shaped as rectangular prisms, which are arranged longitudinally between the surface plates 311, 312. The elements 331 are arranged so that they are not in contact with each other, whereby channels 332 are formed between them, along which channels the gas can flow. The elements 331 in the damping device 300 are arranged so that there are channels only in one direction.

FIG. 4 shows a propeller-driven vessel 400 according to an embodiment of the invention. The vessel 400 uses an inboard motor (not shown in the figure) as a power source, which motor rotates the propeller 420 by means of an axis 410. A damping device 430 has been attached to the bottom of the vessel 400 in order to reduce vibrations of the body of the vessel 400 caused by the pressure wave generated by the propeller 420.

The damping device 430 is attached above the propeller 420 in a point, where the sweep of the pressure wave provided by the propeller 420 mainly hits. A recess 440 has been made in the bottom of the vessel 400 for the damping device 430, in which recess the damping device 430 is attached.

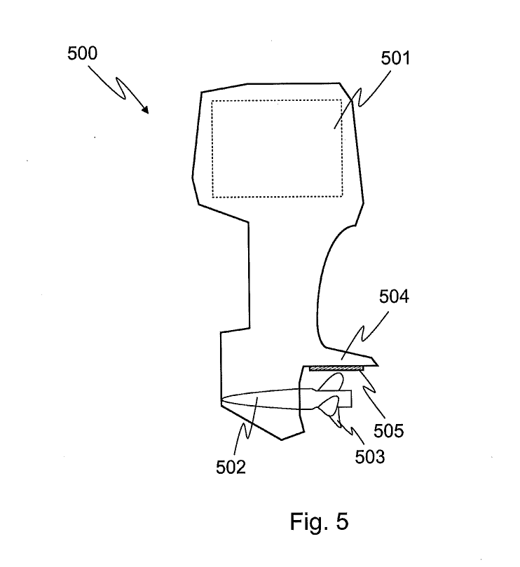

FIG. 5 shows an outboard motor 500 to be attached to a boat according to an embodiment of the invention. The outboard motor 500 comprises a motor 501, which rotates the propeller 503 via a propeller axis 502. A cavitation plate 504 is situated above the propeller 503. A damping device 505 is attached to the lower surface of the cavitation plate 504, above the propeller 503, which damping device dampens vibrations directed at the boat via the outboard motor 500.

It is obvious to a person skilled in the art that the invention is not limited merely to the above-described examples, but the invention may vary within the scope of the claims presented below. The dependent claims present some possible embodiments of the invention, and they are as such not to be considered to restrict the protective scope of the invention.

1. A damping device for damping pressure waves, which damping device comprises a surface structure, which delimits a closed space, which contains gas, wherein the damping device comprises a flexible structure, which is arranged in the closed space delimited by the surface structure, and which flexible structure forms channels, through which the gas can flow.

2. The damping device according to claim 1, wherein the surface structure comprises a first surface plate and a second surface plate, which are attached together at their edges.

3. The damping device according to claim 2, wherein the flexible structure comprises tubes, which are arranged longitudinally between the surface plates.

4. The damping device according to claim 3, wherein the tubes are arranged to be parallel with each other.

5. The damping device according to claim 3, wherein the tubes are arranged in at least two layers.

6. The damping device according to claim 2, wherein the flexible structure comprises elements shaped like rectangular prisms (331), which are arranged longitudinally between the surface plates.

7. The damping device according claim 1, wherein the flexible structure is attached to the inner surface of the surface structure.

8. The damping device according to claim 1, wherein the damping device has a plate-like shape.

9. A propeller-driven vessel, wherein the vessel comprises a damping device according to claim 1, which damping device is arranged between the propeller and the bottom of the vessel.

10. The vessel according to claim 9, wherein the damping device is attached to the bottom of the vessel.

11. The vessel according to claim 10, wherein the damping device is attached to a recess in the bottom of the vessel.

12. The vessel according to claim 10, wherein the bottom of the vessel forms a part of the surface layer of the damping device.

13. A propulsion device, which comprises a propeller and a cavitation plate arranged in connection with the propeller, wherein the propulsion device comprises a damping device according to claim 1 attached to the cavitation plate.
